(19) United States
(12) Patent Application Publication
(10) Pub. No.: US 2018/0176738 A1
(43) Pub. Date: Jun. 21, 2018

(54) ORTHOGONAL FREQUENCY DIVISION MULTIPLEXING (OFDM) RECEIVER AND SPEED MEASURING METHOD WITH THE OFDM RECEIVER

(71) Applicants: NANNING FUGUI PRECISION INDUSTRIAL CO., LTD., Nanning (CN); HON HAI PRECISION INDUSTRY CO., LTD., New Taipei (TW)

(72) Inventor: HSIAO-JEN TSAI, New Taipei (TW)

(21) Appl. No.: 15/390,739

(22) Filed: Dec. 27, 2016

(30) Foreign Application Priority Data
Dec. 15, 2016 (TW) 105141604

(51) Int. Cl. H04W 4/02; H04L 27/26; H04L 12/24; H04L 29/06; H04L 12/803

(52) U.S. Cl. CPC H04W 4/027; H04L 27/265; H04L 41/0681; H04W 84/12; H04L 47/125; H04L 27/2601; H04L 69/22

(57) ABSTRACT

Without using GPS system, an orthogonal frequency division multiplexer (OFDM) receiver can measure a speed value of an movable terminal when moving. The OFDM receiver includes a radio frequency (RF) receiving module and a processing module. The movable terminal sends data in packets as Wi-Fi signals, the processing module includes a processing unit coupled to the RF receiving module and a storing unit. The storing unit stores a plurality of speed mapping tables, the RF receiving module receives packet from the moving movable terminal and the processing unit calculates a Doppler-effect correlation value of the movable terminal, the speed mapping table indicating speed by matching the correlation value from the plurality of speed mapping tables. A speed measuring method is also provided.

### FIELD

The subject matter herein generally relates to wireless communication.

### BACKGROUND

Through global positioning system (GPS) signals, the GPS is used to measure a speed value of a movable terminal.

### BRIEF DESCRIPTION OF THE DRAWINGS

Implementations of the present disclosure will now be described, by way of example only, with reference to the attached figures.

FIG. 1 is a block diagram of one exemplary embodiment of an OFDM receiver and a movable terminal.

FIG. 2 is a block diagram of one exemplary embodiment of the OFDM receiver of FIG. 1.

FIG. 3 is a graphic depiction between correlation values and speed values (packets) from one exemplary embodiment of the system of FIG. 1.

FIG. 4 is a speed mapping table of the P5 packet of the graphic depiction of FIG. 3.

FIG. 5 is a flow chart of one exemplary embodiment of a speed measuring method.

FIG. 6 is a flow chart of one exemplary embodiment of a block 102 of the speed measuring method of FIG. 5.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The term “coupled” is defined as connected, whether directly or indirectly through intervening components, and is not necessarily limited to physical connections. The connection can be such that the objects are permanently connected or releasably connected. The term “comprising,” when utilized, means “including, but not necessarily limited to”; it specifically indicates open-ended inclusion or membership in the so-described combination, group, series, and the like.

The present disclosure is described in relation to an orthogonal frequency division multiplexer (OFDM) receiver and a speed measuring method with the OFDM receiver for measuring a speed value of a mobile terminal, but without a GPS.

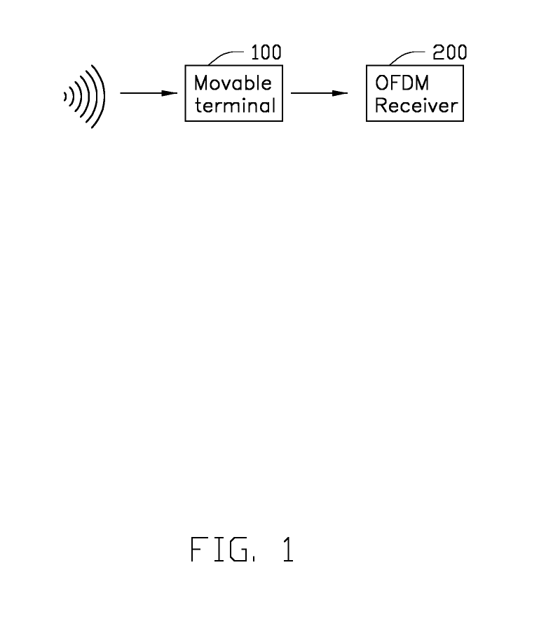

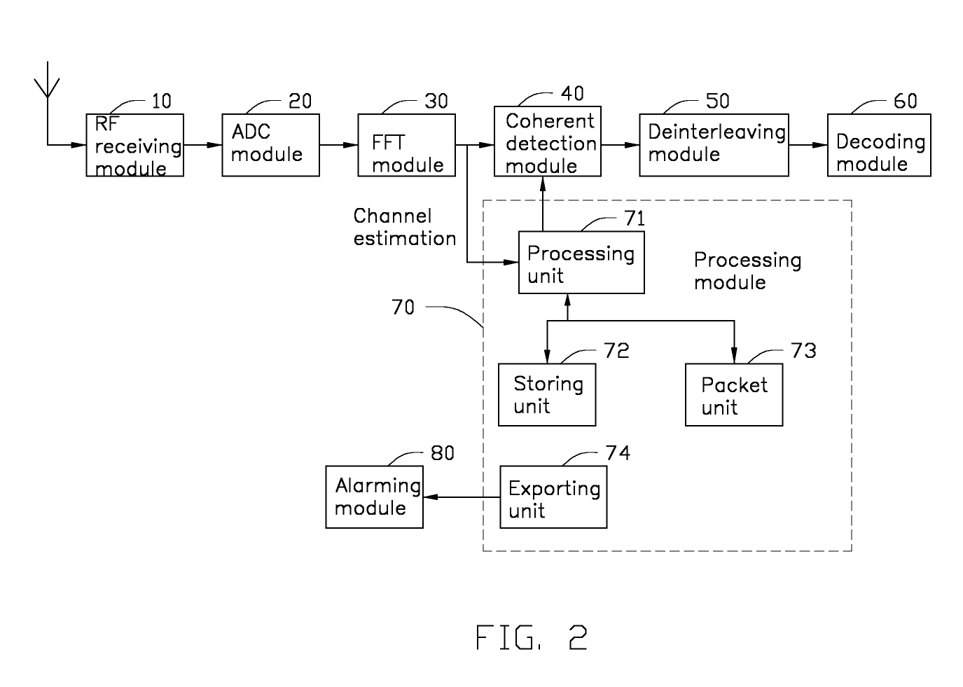

FIGS. 1-2 illustrate an exemplary embodiment of an OFDM receiver (OFDM receiver 200). The OFDM receiver 200 is configured to measure a speed value of a movable terminal 100. The OFDM receiver 200 comprises a radiofrequency (RF) receiving module 10, an analog to digital converter (ADC) module 20, a Fast Fourier transformation (FFT) module 30, a coherent detection module 40, a deinterleaving module 50, a decoding module 60, a processing module 70, and an alarming module 80. The movable terminal 100 is configured to is coupled to a Wi-Fi signal. The movable terminal 100 can be an electronic device with Wi-Fi function, such as a mobile phone or a panel computer.

The processing module 70 comprises a processing unit 71, a storing unit 72, a packet unit 73, and an exporting unit 74. The RF receiving module 10 is coupled to the ADC module 20. The ADC module 20 is coupled to the FFT module 30. The FFT module 30 is coupled to the coherent detection module 40. The FFT module 30 is coupled to the processing unit 71 through channel estimation. The processing unit 71 is coupled to the storing unit 72 and the packet unit 73. The exporting unit 74 is coupled to the alarming module 80. The coherent detection module 40 is coupled to the deinterleaving module 50. The deinterleaving module 50 is coupled to the decoding module 60. The decoding module 60 comprises an output terminal (not labeled).

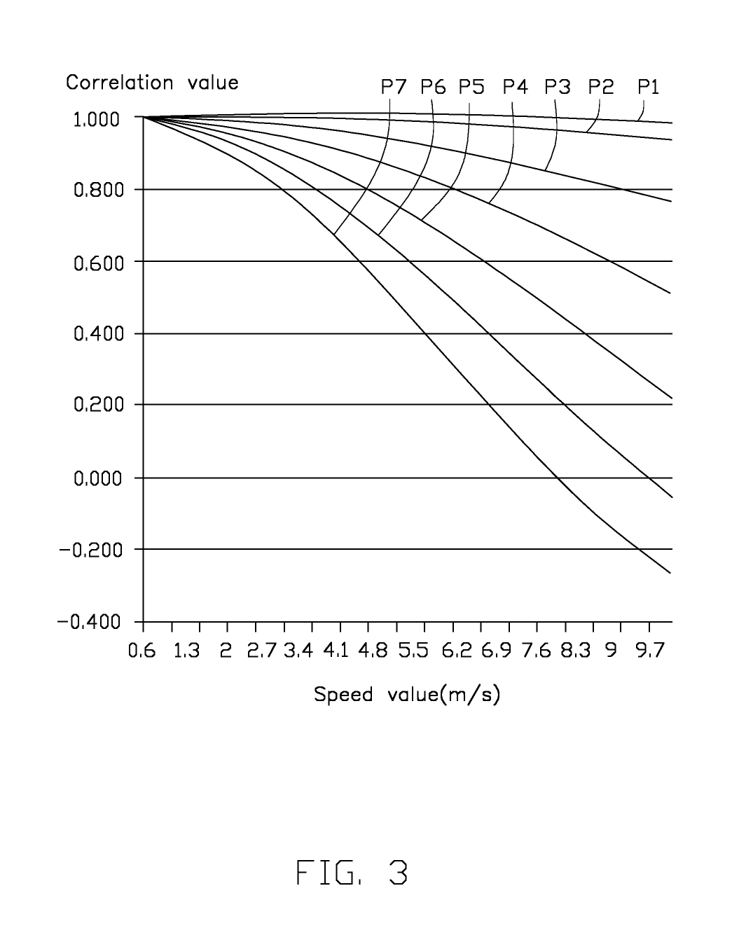

The movable terminal 100 sends a packet to the movable terminal 100 when connected to a Wi-Fi device (not shown). The Wi-Fi device is configured to transmit and receive Wi-Fi signals. The Wi-Fi device can be a switch or a mobile communication device. The movable terminal 100 is configured to connect to the Wi-Fi signals. The packet is a signal. A distance between movable terminal 100 and the Wi-Fi device is changed when the movable terminal 100 moves, thus the movable terminal 100 will send different packets when a distance between movable terminal 100 and the Wi-Fi device changes. Each packet corresponds to a speed value and a correlation value. FIG. 3 illustrates the movable terminal 100 sending seven packets, namely a first packet P1, a second packet P2, a third packet P3, a fourth packet P4, a fifth packet P5, a sixth packet P6, and a seventh packet P7. Each length of the packets P1-P7 is different. Each time that the movable terminal 100 sends the packets P1-P7 is different. The times at which the movable terminal 100 respectively sends the packets P1-P7 is 500 microseconds (μs), 1 millisecond (ms), 2 ms, 3 ms, 4 ms, 5 ms, and 6 ms.

The movable terminal 100 sends a packet when moving. The RF receiving module 10 is configured to receive the packet from the movable terminal 100 and send the packet to the ADC module 20. The ADC module 20 is configured to convert the packet to a digital signal and send the packet to the FFT module. The FFT module 30 is configured to convert the packet from a time domain signal to a frequency domain signal and send the packet to the processing unit 71. The processing unit 71 is configured to calculate a correlation value in relation to the speed value of the movable terminal 100 when moving, according to Doppler effect. The storing unit 72 stores a plurality of speed mapping tables. Each speed mapping table stores a plurality of speed values of the moving movable terminal 100 and a plurality of correlation values in relation to the plurality of speed values. Each speed value corresponds to a correlation value, thus the processing unit 71 can find a speed value matching the correlation value through the correlation value, to obtain the speed value of the moving movable terminal 100. The packet unit 73 is configured to obtain a length of the packet.

The exporting unit 74 is configured to export the speed value of the movable terminal 100. In an exemplary embodiment, the exporting unit 74 exports the speed value of the movable terminal 100 to the alarming module 80, thereby enabling the alarming module 80 to sound a warning according to the speed value of the movable terminal 100. For example, when a user B with movable terminal 100 moves quickly toward a user A, the alarming module 80 sounds a warning to the user A to remind the user A, thereby avoiding the user B striking the user A.

The processing unit 71 sends the correlation value to the coherent detection module 40. The coherent detection module 40 is configured to coherently detect the correlation value and send the correlation value to the deinterleaving module 50. The deinterleaving module 50 is configured to scan and stagger the correlation values and send the correlation values to the decoding module 60 when receiving a plurality of correlation values. The decoding module 60 is configured to decode the correlation values and output the correlation values through the output terminal.

In the exemplary embodiment, the processing unit 71 calculates the correlation value as follows: rt(1)=J0(2π*fmax*l*Ts)=J0(π*fc*(v/c)*l*Ts). The rt(1) represents a correlation value, the fmax represents a maximum doppler effect frequency value, the fc represents a transmission frequency value of the packet, the v represents a speed value of the movable terminal 100 when moving, the c represents a light velocity, the l represents a length of the packet (the packet unit 73 is configured to obtain the length of the packet 1), the Ts represents a time of a cycle time, and the l*Ts represents a time of the movable terminal 100 sending a packet (for example, in the exemplary embodiment, a time of the movable terminal 100 sending a fifth packet P5 is 4 ms, thus, l*Ts=4 ms).

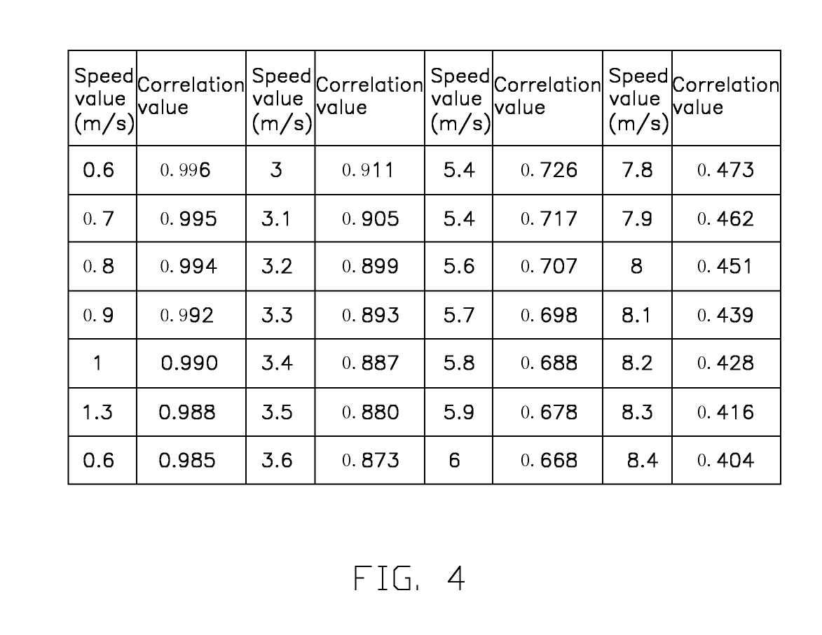

FIG. 4 illustrates that the storing unit 72 stores a speed mapping table with a plurality of speed values and a plurality of correlation values of the packet P5. In an exemplary embodiment, the processing unit 71 finds the speed value 3 matching the correlation value 0.911 through the correlation value 0.911. The speed value of the movable terminal 100 is thus found to be 3 meters/second (3 m/s).

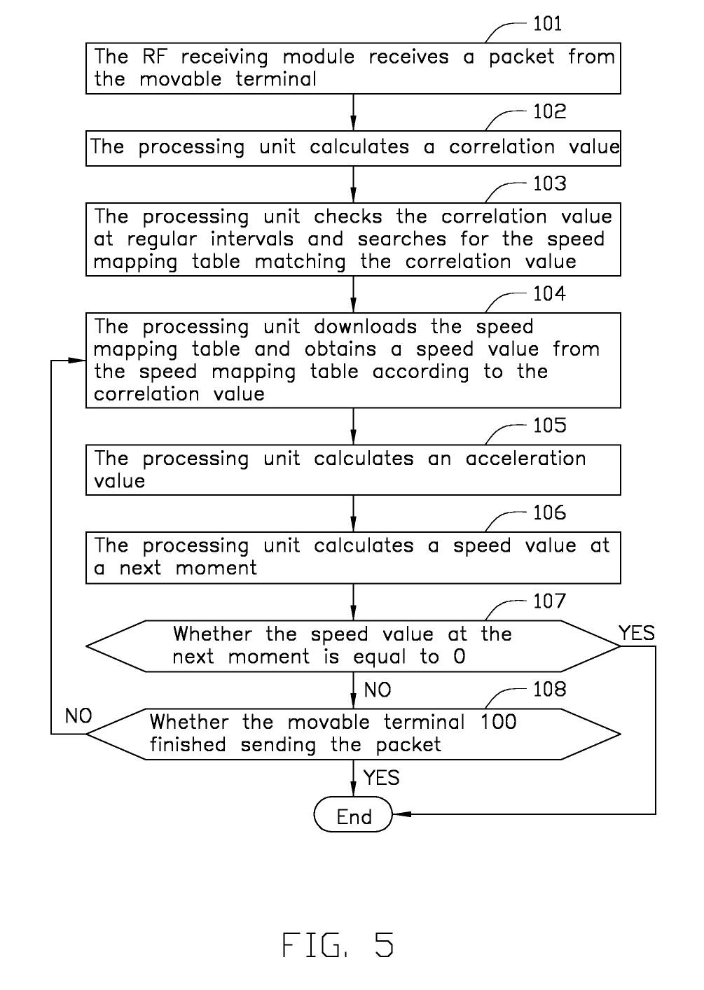

FIG. 5 illustrates a flowchart of a method in accordance with an example embodiment. A speed measuring method is provided by way of example, as there are a variety of ways to carry out the method. The speed measuring method described below can be carried out using the configurations illustrated in FIGS. 1-2, for example, and various elements of these figures are referenced in explaining speed measuring method. The illustrated order of blocks is by example only and the order of the blocks can change. Additional blocks may be added or fewer blocks may be utilized without departing from this disclosure. The speed measuring method can begin at block 101.

At block 101, the RF receiving module 10 receives a packet from the movable terminal 100.

At block 102, the processing unit 71 calculates a correlation value of the movable terminal 100 according to the Doppler effect. Specifically, the processing unit 71 calculates the correlation value of the movable terminal 100 when the movable terminal 100 moves.

At block 103, the processing unit 71 checks the correlation value at regular intervals, searches for the speed mapping table matching the correlation value from the speed mapping tables. Specifically, in an exemplary embodiment, the processing unit 71 finds a speed mapping table matching the correlation value 0.911 of the fifth packet P5 when calculating the correlation value to be 0.911.

At block 104, the processing unit 71 downloads the speed mapping table and obtains a speed value matching the correlation value from speed mapping table according to the correlation value. Specifically, in an exemplary embodiment, the processing unit 71 downloads the speed mapping table corresponding to the fifth packet P5, searches for the correlation value 0.911 matching a speed value 3 in the speed mapping table in relation to the fifth packet P5, thus, the processing unit 71 obtains a speed value of the movable terminal 100 is 3 m/s.

At block 105, the processing unit 71 calculates an acceleration value between two neighboring speed values at two neighboring moments. Specifically, in an exemplary embodiment, the processing unit 71 calculates an acceleration a(t) at time t as follows: acceleration a(t)=(V(t)−V(t−1))/ [symbol] t, the V(t) is a speed value of the movable terminal 100 at time t, V(t−1) is a speed value of the movable terminal 100 at time t−1, [symbol] t is an interval between the time t and the time t−1.

At block 106, the processing unit 71 calculates a speed value of the movable terminal 100 at a next moment according to the acceleration value. Specifically, in one exemplary embodiment, the processing unit 71 can calculate a speed value V(t+1) of the movable terminal 100 at a next moment t+1 as follows: V(t+1)=V(t)+a(t)* [symbol] t. The V(t) is a speed value of the movable terminal 100 at this moment (such as, the moment t), a(t) is an acceleration value of the movable terminal 100 at this moment (such as, the moment t), [symbol] t is an interval between the time t+1 and the time t.

At block 107, the speed value of the movable terminal 100 at the next moment is determined whether to be equal to 0. If yes, the method goes to ending; if no, the method goes to goes to block 108. Specifically, the next moment is the moment t+1.

At block 108, the movable terminal 100 is determined whether to be finished sending the packet. If yes, the method goes to ending; if no, the method goes to goes to block 102. Specifically, the processing module 70 determines the movable terminal 100 to finish sending the packet when the RF receiving module 10 cannot receive the packet from the movable terminal 100, and the processing module 70 determines the movable terminal 100 to unfinish sending the packet when the RF receiving module 10 can receive the packet from the movable terminal 100.

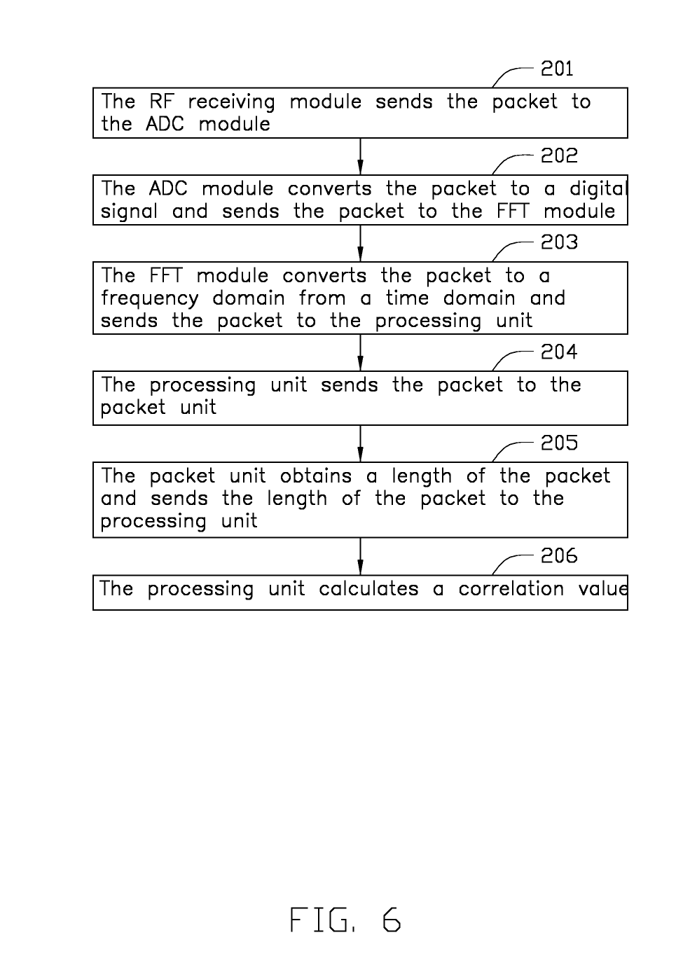

FIG. 6 illustrates a flowchart of the block 102. The block 102 can begin at block 201.

At block 201, the RF receiving module 10 sends the packet to the ADC module 20.

At block 202, the ADC module 20 converts the packet to a digital signal and sends the packet to the FFT module 30.

At block 203, the FFT module 30 converts the packet to a frequency domain from a time domain and sends the packet to the processing unit 71.

At block 204, the processing unit 71 sends the packet to the packet unit 73.

At block 205, the packet unit 73 obtains a length of the packet and sends the length of the packet to the processing unit 71.

At block 206, the processing unit calculates a correlation value 71 according to the Doppler effect. Specifically, the processing unit 71 calculates the correlation value as follows: rt(1)=J0(2π*fmax*l*Ts)=J0(2π*fc*(v/c)*l*Ts).

In the exemplary embodiment, when the movable terminal 100 is connected to the Wi-Fi signal, the OFDM receiver 200 can calculate a speed value of the movable terminal 100 moving without a GPS, thereby enabling the user to conveniently measure the speed value of the movable terminal 100 through Wi-Fi signals from a switch or a mobile communication device, in an indoor or with a weak GPS signal.

It is to be understood that even though numerous characteristics and advantages have been set forth in the foregoing description of embodiments, together with details of the structures and functions of the embodiments, the disclosure is illustrative only and changes may be made in detail, including in the matters of shape, size, and arrangement of parts within the principles of the disclosure to the full extent indicated by the broad general meaning of the terms in which the appended claims are expressed.

What is claimed is:

1. An orthogonal frequency division multiplexing (OFDM) receiver for measuring a speed value of a movable terminal, comprising:
a radio frequency (RF) receiving module; and
a processing module comprising:
a processing unit coupled to the RF receiving module; and
a storing unit coupled to the processing unit;
wherein the storing unit stores a plurality of speed mapping tables;
wherein the movable terminal sends a packet when being connected to a wireless fidelity (Wi-Fi) signal;
wherein the RF receiving module receives the packet from the movable terminal;
wherein the processing unit is configured to:
calculate a correlation value of the movable terminal according to Doppler effect;
search for a speed mapping table matching the correlation value from the plurality of speed mapping tables; and
search for a speed value matching the correlation value in the searched speed mapping table.

2. The OFDM receiver of claim 1, wherein the processing module further comprises a packet unit, the packet unit is coupled to the processing unit, the packet unit obtains a length of the packet, and the packet unit is configured to send the length of the packet to the processing unit.

3. The OFDM receiver of claim 1, further comprises a FFT module, wherein the FFT module is coupled to the RF receiving module and the processing unit, the FFT module converts the packet to a frequency domain from a time domain when receiving the packet, and the FFT module sends the packet to the processing unit when converting the packet to the frequency domain from the time domain.

4. The OFDM receiver of claim 1, wherein the processing unit calculates an acceleration value between two neighboring speed values at two neighboring moments when finding the speed value matching the correlation value.

5. The OFDM receiver of claim 1, wherein the processing module further comprises an exporting unit, the exporting unit is configured to export the speed value.

6. The OFDM receiver of claim 5, further comprises an alarming module, wherein the alarming module is coupled to the exporting unit, the exporting unit exports the speed value to the alarming module, and the alarming module sounds a warning according to the speed value.

7. The OFDM receiver of claim 1, further comprises a coherent detection module, wherein the coherent detection module is coupled to the FFT module and the processing unit, the processing unit is configured to send the correlation value send to the coherent detection module, and the coherent detection module is configured to detect the correlation value.

8. The OFDM receiver of claim 7, further comprises a deinterleaving module, wherein the deinterleaving module is coupled to the FFT module and the processing unit, the coherent detection module is configured to send the correlation value to the deinterleaving module after detecting the correlation value, and the deinterleaving module is configured to staggered scan the correlation values when receiving a plurality of correlation values.

9. A speed measuring method for measuring a speed value of a movable terminal, comprising:
receiving a packet from the movable terminal by a RF receiving module;
calculating a correlation value according to Doppler effect by a processing unit;
search for a speed mapping table matching the correlation value from a plurality of speed mapping tables by the processing unit;
search for a speed value matching the correlation value from the searched speed mapping table matching by the processing unit.

10. The speed measuring method of claim 9, further comprising a step of calculating an acceleration value between two neighboring speed values by the processing unit after finding the speed value matching the correlation value.

11. The speed measuring method of claim 10, further comprising a step of calculating a speed value of the movable terminal at a next moment by the processing unit after the step of calculating an acceleration value between two neighboring speed values by the processing unit.

12. The speed measuring method of claim 9, further comprising a step of obtaining a length of the packet by a packet unit after the step of the RF receiving module receiving the packet from the movable terminal.

13. The speed measuring method of claim 12, further comprising a step of sending the packet to the processing unit by the packet unit after the step of obtaining the length of the packet by the packet unit.

14. The load balancing system of claim 9, further comprising a step of checking the correlation value at regular intervals by the processing unit after the step of calculating the correlation value according to the Doppler effect by the processing unit.

15. A speed measuring method for measuring a speed value of a movable terminal, comprising:
receiving a packet from the movable terminal by a RF receiving module;
obtaining a length of the packet by a processing module;
calculating a correlation value with the length of the packet according to Doppler effect by a processing unit of the processing module;
search for a speed mapping table matching the correlation value from a plurality of speed mapping tables by the processing unit;
search for a speed value matching the correlation value from the searched speed mapping table matching by the processing unit.

16. The speed measuring method of claim 15, further comprising a step of calculating an acceleration value between two neighboring speed values by the processing unit after finding the speed value matching the correlation value.

17. The speed measuring method of claim 16, further comprising a step of calculating a speed value of the movable terminal at a next moment by the processing unit after the step of calculating an acceleration value between two neighboring speed values by the processing unit.

18. The speed measuring method of claim 15, wherein a storing unit of the processing module stores the plurality of speed mapping tables, each speed mapping table stores a plurality of speed values of the movable terminal and a plurality of correlation values in relation to the speed values.

19. The load balancing system of claim 15, further comprising a step of checking the correlation value at regular intervals by the processing unit after the step of calculating the correlation value according to the Doppler effect by the processing unit.

20. The speed measuring method of claim 15, wherein the processing unit calculates the correlation value as follows: rt(1)=J0(2π*fmax*l*Ts)=J0(2π*fc*(v/c)*l*Ts), wherein the rt(1) represents a correlation value, the fmax represents a maximum doppler frequency value, the fc represents a transmission frequency value of the packet, the v represents a speed value of the movable terminal moving, the c represents a light velocity, the l represents a length of the packet, the Ts represents a time of a cycle time, the l*Ts represents a time of the movable terminal sending a packet.
